(19) United States
(12) Patent Application Publication
(10) Pub. No.: US 2012/0286010 A1
(43) Pub. Date: Nov. 15, 2012

(54) Patient Chart Transport Receptacle

(76) Inventor: Lisa C. Mann, Flemington, NJ (US)

(21) Appl. No.: 13/105,456

(22) Filed: May 11, 2011

(51) Int. Cl. B60R 9/00

(52) U.S. Cl. 224/407

(57) ABSTRACT

A rectangular enclosing container with dimensions to accommodate a typical hospital chart is open at the top for insertion and removal of the chart, and has an arcuate slot in the front face to facilitate access to the chart. From the top rear face of the container extend one or more means, such as hooks, for attaching the container to a patient bed, gurney or stretcher. The container is fabricated from a hard, non-porous material, such as plastic, that is wipe-down cleanable. The material forming the container is opaque or darkly translucent so as to protect the privacy of the patient's medical data. The attachment means assures that the chart will always be readily accessible, and the access slot provides for easy insertion and removal of the chart from the container. The non-porous, wipe-down cleanable surfaces of the receptacle prevent the spread of pathogens during the handling and transport of the patient chart. An alternate design allows the front page of the chart to be viewed without removing the chart from the receptacle, thereby allowing a physician, nurse or other hospital personnel to check the patient's name, status or other information quickly, without handling the chart itself.

### BACKGROUND OF THE INVENTION

The present invention relates to the field of devices for containing, storing and transporting documents, and more particularly to document containers designed to store and transport medical documents in a secure, confidential and hygienic manner.

The handling of medical charts and documents for hospital patients or patients in the outpatient setting involves issues of accessibility, chart integrity, hygiene and privacy. A medical chart must be readily available at all times so that a nurse or physician may obtain and enter up-to-the-minute information on the patient's symptoms, prognosis, procedures and medications. While remaining with a patient throughout transport, the chart must be maintained in its entirety, without being subject to accidental loss or misplacement of contents. Also, because patient charts are handled by numerous medical personnel, they are apt to become vehicles for spreading pathogens if not adequately protected. While the chart's information must be accessible to the appropriate medical professionals, the privacy of the patient's sensitive medical data must also be protected.

The prior art in this field does not disclose a device for handling and storing hospital patient charts which simultaneously addresses the needs of accessibility, chart integrity, hygiene and privacy.

The patent to Dawson (U.S. Pat. No. 955,325) discloses a spring-loaded clip board binder typical of those used for holding patient charts. A binder with attachment means is taught by the Millert patent (U.S. Pat. No. 546,492). A patient's file chart clip is taught by the patent to Arblaster (U.S. Pat. No. 3,397,434). None of these devices provides for enclosure of the chart for hygienic and privacy purposes.

The patent of Ho (U.S. Pat. No. 6,042,291) discloses a fully-enclosing rectangular plastic document holder, but it is designed to hold single sheets flexibly within a looseleaf-type binder. The document container taught by the patent application of Giglio et al. (U.S. 2008/0296313) uses a translucent plastic material to display documents, which is inconsistent with the goal of privacy.

The patents of Simonson (U.S. Pat. No. 1,967,632) and Wittke (U.S. Pat. No. 7,374,143), which teach the use of transparent plastic covers to protect clipboards from the elements, are inappropriate for medical use, since they lack features to maintain document privacy and insure hygienic handling.

A clipboard attached to the lid of a hinged document receptacle is taught by the patent to Gaska (U.S. Pat. No. 6,637,774), but this device does not protect the clipboard documents themselves, but instead provides storage space for paper and writing utensils.

Consequently, there remains a need, not addressed by the prior art, for a hospital patient chart receptacle that allows convenient access to the chart documents, while at the same time preserving their privacy and maintaining a pathogen-free enclosure.

### SUMMARY OF THE INVENTION

The present invention comprises a rectangular enclosing container with dimensions to accommodate a typical hospital chart, of approximately 9″ in width by 12″ in length, with a depth of about 3″-4″. The container is open at the top for insertion and removal of the chart, and with an arcuate slot in the front face to facilitate access to the chart. From the top rear face of the container extend one or more means, such as hooks, for attaching the container to a patient bed, gurney or stretcher. The container is fabricated from a hard, non-porous material, such as plastic, that is wipe-down cleanable. The material forming the container is opaque or darkly translucent so as to protect the privacy of the patient's medical data, in accordance with the Health Insurance and Portability Act (HIPPA). Alternately, only the front panel of the container is opaque or darkly translucent, while the remaining panels—back, bottom and sides—are light translucent or transparent.

In this design, the attachment means assures that the chart will always be readily accessible at the bedside or gurney of the patient. The access slot on the front face of the receptacle provides for easy insertion and removal of the chart from the container. Privacy of patient information is protected by the opacity of the material comprising the receptacle or its front panel, or sufficient translucency of same to prevent reading of the chart within. The non-porous, wipe-down cleanable surfaces of the receptacle prevent the spread of pathogens during the handling and transport of the patient chart. The attachment means obviates the current practice of placing charts directly on the patients' bed or under the mattress.

An alternate design of the present invention, described hereinbelow, allows the front cover of the chart to be viewed without removing the chart from the receptacle. This alternate version of the receptacle has the advantage of allowing a physician, nurse or other hospital personnel to check the patient's name, status or other information quickly, without handling the chart itself.

### BRIEF DESCRIPTION OF THE DRAWINGS

FIG. 1 is a front perspective view of the first preferred embodiment of the present invention.

FIG. 2 is a front perspective view of the second preferred embodiment of the present invention.

### DETAILED DESCRIPTION OF THE PREFERRED EMBODIMENTS

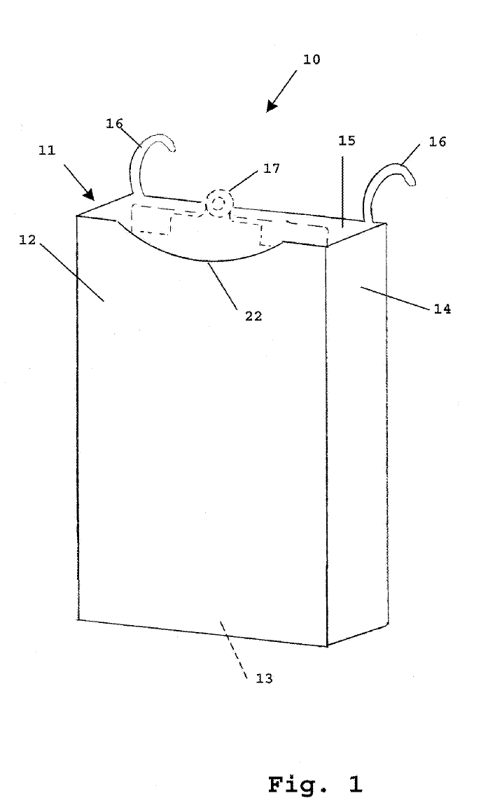

Referring to FIG. 1, the first embodiment of the present invention 10 comprises a rectangular enclosing container 11 with dimensions, to accommodate a typical hospital chart 17, of approximately 9″ in width by 12″ in length, with a depth of about 3″-4″. The container 11 comprises a front panel 12, a bottom panel 13, two sides panels 14, and a back panel 15. The container 11 is open at the top for insertion and removal of the chart 17, and with an arcuate slot 22 in the front panel 12 to facilitate access to the chart 17. From the top of the rear panel 15 of the container 11 extend one or more attachment means 16, such as hooks, for attaching the container 11 to a patient bed or gurney. The container 11 is fabricated from a hard, non-porous material, such as plastic, that is wipe-down cleanable. The material forming the front panel 12 of the container 11 is opaque or darkly translucent so as to obscure the chart 17 and render it unreadable unless removed from the container 11.

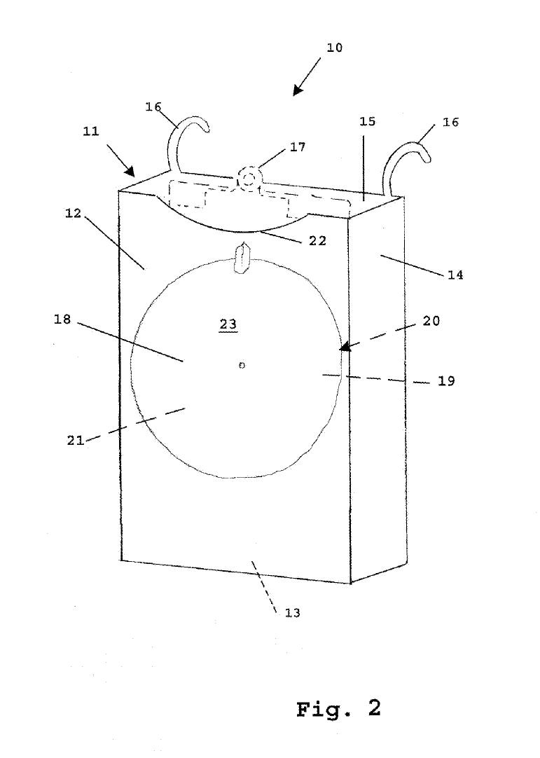

FIG. 2 illustrates the second embodiment of the present invention 10. In this embodiment, a central area 20 of the front panel 12 of the container 11 comprises a circular, transparent first linear polarizer 19 on its outer surface and a matching circular concave lens 21 on its inner surface. Rotatably attached to and covering this central area 20 is a disk 18 comprising a transparent second linear polarizer 23. When the disk 18 is rotated so that the polarization axis of the second linear polarizer 23 is perpendicular to the polarization axis of the first linear polarizer 19, the central area 20 of the front panel 12 of the receptacle is opaque, and the front page of the chart 17 within the container 11 is not visible. When the disk 18 is rotated so that the polarization axis of the second linear polarizer 23 is aligned with the polarization axis of the first linear polarizer 19, the central area 20 becomes transparent, and the front page of the patient chart 17 can be viewed through the concave lens 21 comprising the inner surface of the central area 20.

Although the preferred embodiments of the present invention has been disclosed for illustrative purposes, those skilled in the art will appreciate that many additions, modifications and substitutions are possible, without departing from the scope and spirit of the present invention as defined by the accompanying claims.

What is claimed is:

1. A receptacle for holding a hospital patient's medical chart, comprising:
a rectangular container having an open top, a front panel, a back panel, a bottom panel and two side panels, such that the container encloses an interior space into which the medical chart can be inserted;
one or more attachment means, by which the container can be removably attached to a structural member of a hospital bed, gurney or stretcher;
wherein the top margin of the front panel has an arcuate indentation to facilitate grasping the top of the medical chart and removing it from the container; and
wherein the container is fabricated of a hard, non-porous, wipeable material, and wherein the front panel of the container is opaque or darkly translucent, such that the medical chart is not readable through the front panel.

2. A receptacle for holding a hospital patient's medical chart, comprising:
a rectangular container having an open top, a front panel, a back panel, a bottom panel and two side panels, such that the container encloses an interior space into which the medical chart can be inserted;
one or more attachment means, by which the container can be removably attached to a structural member of a hospital bed, gurney or stretcher;
wherein the top margin of the front panel has an arcuate indentation to facilitate grasping the top of the medical chart and removing it from the container;
wherein the container is fabricated of a hard, non-porous, wipeable material;
wherein the front panel comprises a circular central area and a surrounding peripheral area, and wherein the peripheral area is opaque or darkly translucent, and wherein the central area has an outer surface comprising a transparent first linear polarizer and an inner surface comprising a concave lens; and
wherein the front panel of the container further comprises a disk, which covers and is rotatably attached to the central area of the front panel, and wherein the disk comprises a transparent second linear polarizer, such that, when the disk is rotated so that the polarization axis of the second linear polarizer is perpendicular to the polarization axis of the first linear polarizer, the central area of the front panel of the receptacle is opaque, and medical chart within the container is not readable through the front panel, and such that, when the disk is rotated so that the polarization axis of the second linear polarizer is aligned with the polarization axis of the first linear polarizer, the central area of the front panel becomes transparent, and the front of the medical chart can be viewed through the concave lens comprising the inner surface of the central area of the front panel.
